(19) United States
(12) Patent Application Publication
(10) Pub. No.: US 2005/0028357 A1
(43) Pub. Date: Feb. 10, 2005

(54) BNC driver, a hand driver for twisting-on and rotating-off coaxial BNC connectors

(76) Inventors: Bob B. Lu, Long Beach, CA (US); Jia X. Sheng, Fountain Valley, CA (US)

Correspondence Address: Bob B. Lu, 2721 S. Fragancia Ave., Hacienda Hts, CA, 91745, US

(21) Appl. No.: 10/430,018

(22) Filed: Aug. 8, 2003

(51) Int. Cl. H01R 3/00

(52) U.S. Cl. 29/761; 29/729

(57) ABSTRACT

A special designed hand tool called BNC Driver has been invented. The invention allows the male BNC connectors on the ends of coaxial cables to be easily twisted on to and rotated off from the female BNC connectors, when these female BNC connectors are closely and densely installed in a very limited area where a human hand is very hard to access from.

The whole idea of this invention was originally proposed and provided by Bingzhong Lu (AKA Bob B. Lu), an U.S. citizen, residing in Long Beach, Calif. in June 2002. Later on, following Bob Lu's instruction and his hand drawing, Jia Sheng (AKA Jeffrey Sheng), an U.S. citizen, residing in Fountain Valley, Calif. completed the design of the first prototype with detailed diagrams for production.

After a few times modification, this tool invention was finalized in October, 2002.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The background behind this invention comes from years of experiences on the installation of CCTV system in the field.

One basic requirement of a CCTV surveillance system is recording several camera pictures by using only one recorder. One way to achieve this goal is to use so called multiplexer.

A typical 16-channel multiplexer usually contains at least 32 BNC connectors: 16 for input and 16 for loop-through output. And the back panel of a regular multiplexer has a typical size of 17.5″ (W)×1.75″ (H) only. It is very difficult to change any one of these connectors after all 32 coaxial cables are installed. After the multiplexer along with other equipments are mounted into a fully installed 19″ EIA standard rack or rack cabinet, to check or change any cable with BNC will cause one to sweat.

As a result of the inconvenience to both the installer and the service technician, the need or demand of a special tool may arise. With this tool the installation and after installation service will be a lot easier, a lot quicker and no sweat at all.

The technical field of this invention may be categorized either into hand tools or manual tools. The invented Driver can be applied either in security industry especially in the installation and service of CCTV surveillance systems or in telecommunication industry where BNC connectors are widely used.

### BRIEF SUMMARY OF THE INVENTION

A special designed hand tool called BNC Driver has been invented. The invention allows the male BNC connectors on the ends of coaxial cables to be easily twisted on to and rotated off from the female BNC connectors, when these female BNC connectors are closely and densely installed in a very limited area where a human hand is very hard to access from.

The Driver can be made either by metal, such as Aluminum or Titanium, or by plastics, such as ABS or other substances which can be formed by injection mould.

### BRIEF DESCRIPTION OF THE SEVERAL VIEWS OF THE DRAWING

FIG. 1 is the 3-D view of the invented BNC Driver. (p. 10/12)

FIG. 2 is the front view, side view and top view of the invention. (p. 11/12)

FIG. 3 is the sectional views of the invention, Section (A-A) to (E-E). (p. 12/12)

### DETAILED DESCRIPTION OF THE INVENTION

According to the invention, an aluminum Driver has been designed and constructed for mounting male BNC connectors with coaxial cables onto female BNC connectors which are closely and densely arranged on the rear panel of any video switcher, multiplexer and/or similar equipment such as digital video recording systems with a limited access area.

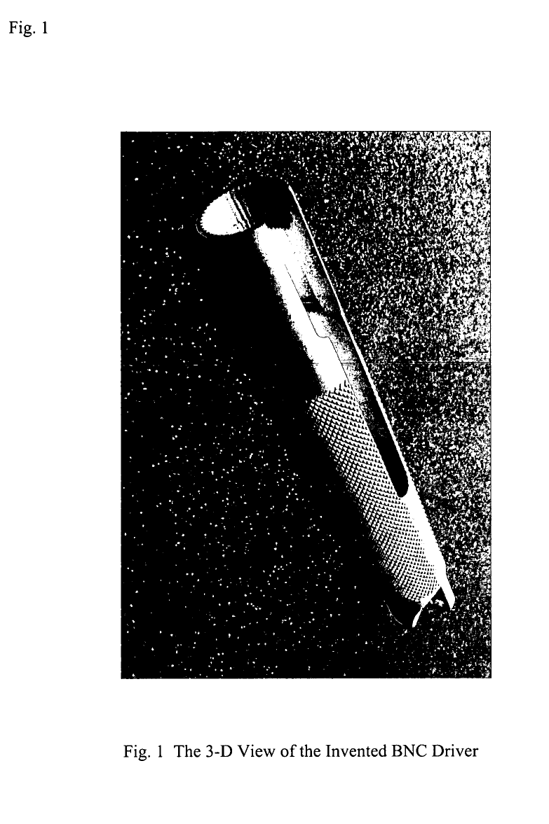

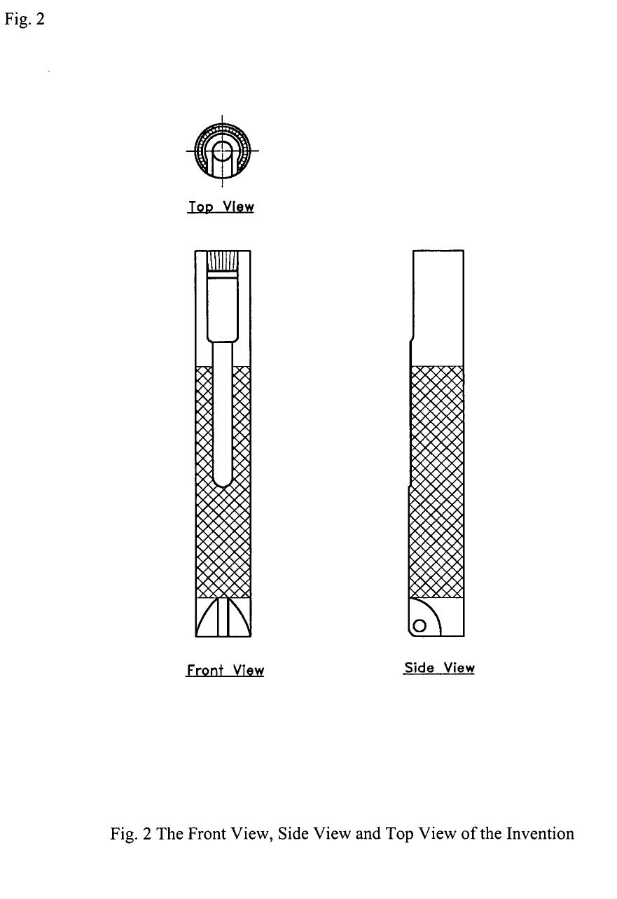

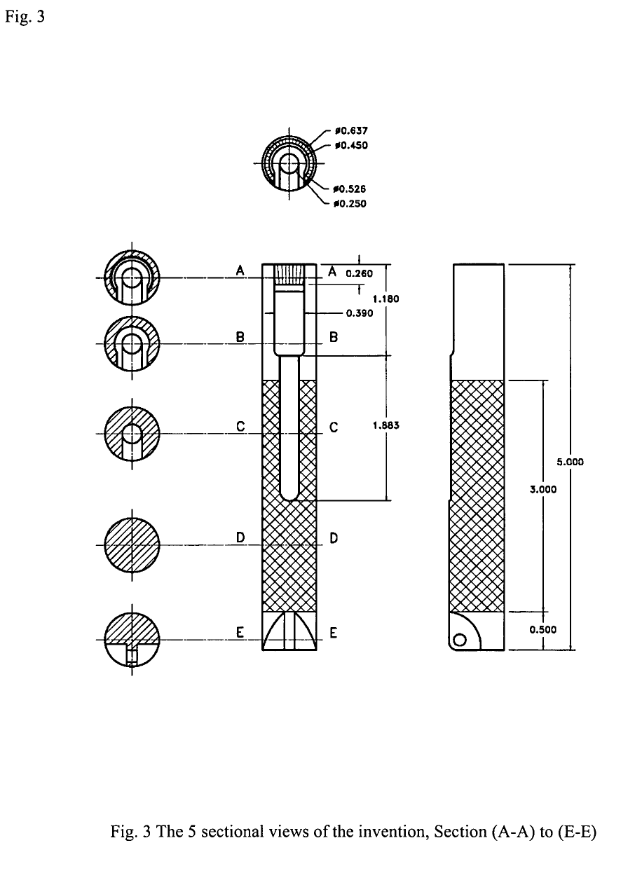

FIG. 1 is the 3-D view of the invented BNC Driver. FIG. 2 shows the front view, side view, and the top view of the invented Driver. And FIG. 3 shows five sections of the invention. The Driver is a one-piece design with five parts. Part (A-A) is the inner-laced stripes which are used to hold the laces on the male BNC connector. Part (B-B) is the space for holding the so called twist-on part of the male BNC connector. Part (C-C) is the narrow opening in which the RG-59 coaxial cable would not be twisted when the Driver is turned around. Part (D-D) is the outer lace on the Driver body. Obviously it is designed to prevent slip from hand or glove. And Part (E-E) is the hole for key chains or key rings.

The nine-step process of making this Driver is:
1. Cut cylindrical bar diameter 0.700″, length 5.00″.
2. Drill blind hole from one end of the bar, dia. 0.250″, deep 3.33″.
3. Drill blind hole from the same end, dia. 0.450″, depth 1.180″.
4. Cut slot from the same end, width 0.250″, depth 3.063″.
5. Cut slot from the same end, width 0.390″, depth 1.180″.
6. Cut cone surface, basic dia. 0.637″×8, depth 0.260″.
7. Cut lines on the cone surface, W×D: 0.012″×0.012″, 35 lines.
8. Cut flat web 0.130″ and drill a hole dia. 0.15″ on the other end of the bar.
9. Make rhombic knurl on the outer surface, length 3.0″.

In accordance with the present invention, the materials used to make this Driver can either be metals or plastics. ABS is one of plastic materials that can be used to make this Driver. Once the mould is made, ABS can be easily injection-formed with large quantity in a very low cost.

Titanium alloy is another good selection for special application due to its light weight and wear-resistance.

1. A single piece manual tool designed with five functions as mentioned in the Detailed Description of the invention above having a straight handle with laced grip part for grasping by a user.

2. The tool of claim 1 wherein said material is hard aluminum.

3. The tool of claim 1 wherein said material is iron, titanium or other alloy.

4. The tool of claim 1 wherein said material is ABS or other hard plastics which can be formed by injection mould.

5. The scope of the protection of our invention includes the way to construct, build, assemble, and/or to produce several grasping functions in one piece.
